(19) United States
(12) Patent Application Publication
(10) Pub. No.: US 2002/0094156 A1
(43) Pub. Date: Jul. 18, 2002

(54) Communication system for the transmission of optical signals

(75) Inventor: Bernd X. Wein, Korntal-Munchingen (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/042,349

(22) Filed: Jan. 11, 2002

(30) Foreign Application Priority Data
Jan. 16, 2001 (DE) 101 01 665.4

(51) Int. Cl. G02B 6/293; H04J 14/02

(52) U.S. Cl. 385/24; 359/127

(57) ABSTRACT

A communication system is specified for the transmission of optical signals which are transmitted in wavelength-division multiplex with different wavelengths via optical fibres. In at least one network node of the communication system, there exist at least one line unit (2) to which the optical fibres (1) are connected, and a cross-connector (6). The cross-connector (6) is connected to the line unit (2) via optical interfaces and signals of the same wavelength are fed in each case by the line unit (2) to two inputs of the cross-connector (6) or are delivered to the line unit (2) by two outputs of said cross-connector. Only one of the corresponding transmission paths is used in each case. In order to reduce the number of color lasers (4) in the line unit (2), signals of each wavelength are delivered by the line unit (2) on one path only to a passive splitter (7), which doubles the respective signal and feeds it on separate paths to the two inputs of the cross-connector (6). In the opposite direction in each case two outputs of the cross-connector (6) are fed on separate paths to a coupler (8), via which the two paths are combined into one transmission path which is connected to one input of the line unit (2) to which a color laser (4) corresponding to the respective wavelength of the optical signals is connected.

### FIELD OF THE INVENTION

The invention relates to the field of telecommunication and more particularly to a communication system for the transmission of optical signals that are transmitted in wavelength-division multiplex with different wavelengths via optical fibres, in which communication system, in at least one network node of the communication system, there exist at least one line unit to which the optical fibres are connected, and a cross-connector, in which communication system the cross-connector is connected to the line unit via optical interfaces and in which communication system signals of the same wavelength are respectively fed by the line unit to two inputs of the cross-connector or are delivered to the line unit by two outputs of said cross-connector, wherein only one of the corresponding transmission paths is used.

### BACKGROUND OF THE INVENTION

Optical fibres are used as the transmission medium for fast data transfer in modern networks. Data or signals are transmitted as digital signals with different wavelengths in wavelength-division multiplex via only one optical fibre. In this case each wavelength is a carrier of an information signal. A known system is the wavelength-division multiplex system. Because of the ever increasing data density, this system is also referred to as a dense wavelength-division multiplex system. The embodiments which follow refer to this system—abbreviated to “DWDM” system in the following text—as representative of all possible wavelength-division multiplex systems.

The optical fibres of such a communication system are connected at network nodes of said communication system to line units which are equipped with a multiplexer/demultiplexer, with color lasers of differing wavelengths, and watchdog units. Also at the network nodes are placed cross-connectors (CC) operating with SDH (Synchronous Digital Hierarchy) technology, for example, by which the signals are output to the “correct” transmission paths according to a management system associated with the system or network, so that they reach the addressed receiver which is connected to the communication system via at least one of the optical fibres.

The line unit is connected to the CC via digital interfaces, for the synchronous transfer mode (STM) for example. For reasons of transmission security, the individual signals assigned to a wavelength are fed to the CC on two separate paths by the line units after demultiplexing. Of the two paths only one is used. In the event of a fault on the respective active path, a switchover to the other path is effected.

In the opposite direction, the signals of one wavelength are likewise transmitted from the CC on two paths to the line unit, of which again in each case only one is used. A colour laser having the appropriate wavelength is provided in the line unit for each of the transmission paths, that is to say for each wavelength. The laser signals are multiplexed in the line unit according to the management system and output to the connected optical fibres of the DWDM system. As high-quality elements, the colour lasers used here operate very reliably. They are correspondingly expensive. Since, because of the two transmission paths, two colour lasers are used in the line unit for each wavelength, the DWDM systems currently in use are very costly.

### BRIEF DESCRIPTION OF THE INVENTION

The object of the invention is to develop the communication system described at the outset so that the expenditure in the network nodes can be reduced.

This object is achieved according to the invention,

in that the signals of each wavelength are delivered by the line unit on one path only to a passive splitter, which doubles the respective signal and feeds it on separate paths to the two inputs of the cross-connector, and

in that two outputs of the cross-connector are fed on separate paths to a coupler, via which the two paths are combined into one transmission path which is connected to one input of the line unit to which a colour laser corresponding to the respective wavelength of the optical signals is connected.

At the network nodes of this communication system, an element that operates as a splitter in one transmission direction and as a coupler in the other transmission direction is interposed between the line unit of the DWDM system and the CC. Each signal, which at the receiving end corresponds to a wavelength, is delivered only once by the line unit of the DWDM system, that is to say to the respective splitter which doubles that same signal, so that two identical signals always arrive at the CC. Furthermore, the CC always delivers—likewise unchanged—two identical optical signals on separate transmission paths extending up to the coupler, which are combined by the coupler into one transmission path and fed to only one colour laser having the appropriate wavelength. In all cases, that is to say also when changing over in the CC the transmission path to be used, only this one colour laser transmits; its output signal is multiplexed according to the management system with the output signals of the other colour lasers having other wavelengths, and is fed to the connected optical fibres of the DWDM system. Thus, compared to the known DWDM systems, 50% of the colour lasers are saved. The security of the transmission is hardly diminished since as already mentioned—these lasers are very reliable. The very short transmission paths between the interfaces of the line unit of the DWDM system and the splitters or couplers, respectively, which are provided only once for the signals of each wavelength, do not affect transmission security. The construction of the line unit of the DWDM system is generally considerably simplified and very economical.

### BRIEF DESCRIPTION OF THE DRAWINGS

An exemplary embodiment of the subject-matter of the invention is illustrated in the drawings, of which:

FIG. 1 shows a schematic representation of an optical communication system with a network node according to the invention.

Fig. shows an enlarged representation of a detail of the network node.

### DETAILED DESCRIPTION OF THE INVENTION

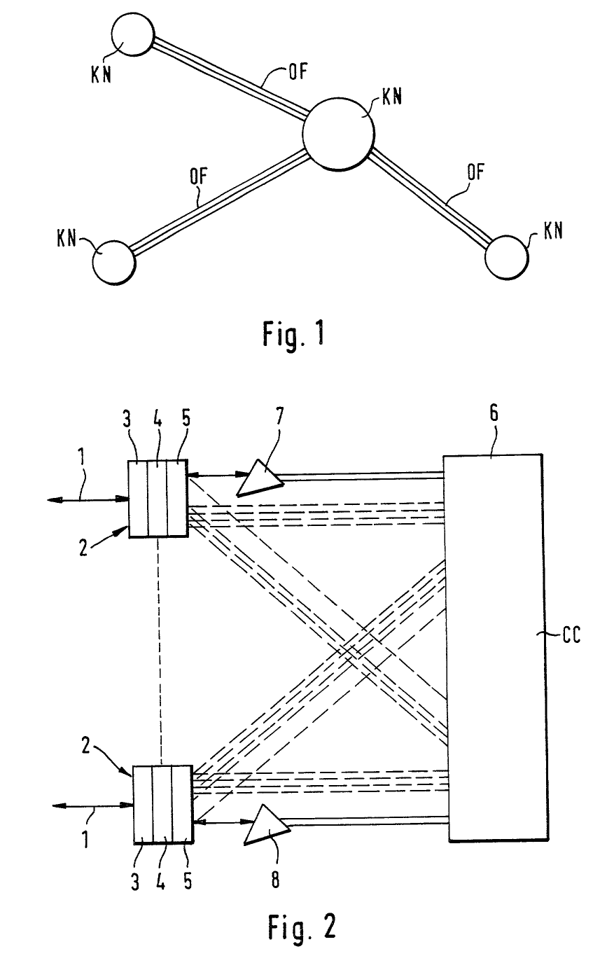

According to the illustration in FIG. 1, an optical communication system can have four network nodes KN, for example, which are connected via a number of optical fibres OF. The fibres OF are usually combined in optical cables. Switching centres or routers, for example, can be connected to the network nodes KN. A management system via whose commands the different transmission paths are switched through in the network nodes KN, is superimposed on the communication system.

To achieve this, for each connected optical fibre 1 a line unit 2 is arranged in the network nodes KN. A multiplexer/demultiplexer 3, a number of colour lasers 4 and a watchdog unit 5 are associated with each line unit 2. Each line unit 2 is connected via digital optical interfaces to inputs of a cross-connector 6. Extending out from the interfaces are several transmission paths for the transmission of the signals arriving via the optical fibres 1, of which in FIG. 2 only one is accurately illustrated, while the others are denoted by broken lines. After demultiplexing, only signals of one wavelength are transmitted on each transmission path, that is to say with black/white lasers, for example. Starting from the line unit 2, each transmission path extends up to a component operating as a splitter or coupler, which in the direction of the cross-connector 6 acts as a passive splitter 7. The transmission path is doubled by the splitter 7, so that two signals having the same wavelength are fed on two separate paths to the cross-connector 6. Of these paths, only one is used. The other can be held in the stand-by mode, for example.

The signals received by the cross-connector 6 are assigned to the correct receiver in accordance with the management system and at the same time are transmitted back to one of the line units 2 via outputs. In this case, for each wavelength, the cross-connector 6 has two outputs, of which only one is used. For each wavelength, two transmission paths extend from the outputs of the cross-connector 6. Here again, only the transmission paths for one wavelength are accurately shown, while the others are again shown by broken lines. The two transmission paths are routed up to the component that is now acting as a coupler 8 and combines the two transmission paths into one transmission path. The latter is connected via one of the digital interfaces to the line unit 2 and thus to one of the colour lasers 4 provided in said line unit. A colour laser 4 is arranged for each interface in the line unit 2. All the lasers 4 have different wavelengths. The output signal of one colour laser 4 is multiplexed with the output signals of the other colour lasers 4 and output on the optical fibre 1 connected to the line unit 2.

The double-function splitter 7/coupler 8 component can be located in the line units 2 or in the cross-connector 6.

What is claimed is

1. A communication system for transmission of optical signals, that are transmitted in wavelength-division multiplex with different wavelengths via optical fibres, in which communication system, in at least one network node of the communication system, there exist at least one line unit to which the optical fibres are connected, and a cross-connector, in which communication system the cross-connector is connected to the line unit via optical interfaces and in which communication system signals of the same wavelength are fed by the line unit to two inputs of the cross-connector or are delivered to the line unit by two outputs of said cross-connector, wherein only one of the corresponding transmission paths is used, wherein
the signals of each wavelength are delivered by the line unit on one path only to a passive splitter, which doubles the respective signal and feeds it on separate paths to the two inputs of the cross-connector, and
outputs of the cross-connector are fed on separate paths to a coupler, via which the two paths are combined into one transmission path which is connected to one input of the line unit to which a colour laser corresponding to the respective wavelength of the optical signals is connected.
